(19) United States
(12) Patent Application Publication
(10) Pub. No.: US 2003/0099016 A1
(43) Pub. Date: May 29, 2003

(54) Fiber optic transceiver array for implementing testing

(75) Inventors: David W. Siljenberg, Byron, MN (US); Randolph B. Heineke, Rochester, MN (US)

Correspondence Address: Charles E Wands, Messrs Allen Dyer Doppelt Milbrath & Gilchrist, 1401 Citrus Center 255 South Orange Avenue, Box 3791, Orlando, FL, 32802-3791, US

(73) Assignee: INTERNATIONAL BUSINESS MACHINES CORPORATION

(21) Appl. No.: 09/995,107

(22) Filed: Nov. 27, 2001

(51) Int. Cl. H04B 10/08; H04B 10/00

(52) U.S. Cl. 359/152; 359/110

(57) ABSTRACT

A fiber optic transceiver array is provided for implementing testing. The fiber optic transceiver array includes a plurality of sequential fiber optic transceiver channels. Each fiber optic transceiver channel includes a photodetector and has a predefined channel width. The photodetector of each sequential fiber optic transceiver channel is spaced apart substantially equal to the predefined channel width. A plurality of test pads is included in each fiber optic transceiver channel. A pair of power pads is included in each fiber optic transceiver channel. The predefined channel width and spacing between adjacent photodetectors is substantially equal to a spacing between fibers in a standard fiber optic cable. The plurality of test pads of each fiber optic transceiver channel includes a predefined sequence three test pads including a ground and a pair of differential channel outputs. Spacing between the differential channel outputs is minimized.

### RELATED APPLICATIONS

Related United States patent applications by Randolph B. Heineke and David John Orser assigned to the present assignee are being filed on the same day as the present patent application and including:

U.S. patent application Ser. No. ______, entitled “FIBER OPTIC TRANSCEIVER ARRAY AND FIBER OPTIC TRANSCEIVER CHANNEL FOR SHORT WAVE FIBER OPTIC COMMUNICATIONS”; and

U.S. patent application Ser. No. ______, entitled “DETECTOR FOR SHORT WAVE FIBER OPTIC COMMUNICATIONS WITH COMPENSATION TO REDUCE DETECTOR JITTER”.

### FIELD OF THE INVENTION

The present invention relates generally to the data communications field, and more particularly, relates to a fiber optic transceiver array for implementing testing.

### DESCRIPTION OF THE RELATED ART

Demand for bandwidth in data communications appears to be generally unlimited. One of the economic considerations to meet this demand is to minimize the physical size of fiber optic transceiver channels. One known arrangement uses an array of integrated photodetector and preamplifiers to reduce the number of components and connections in the fiber optic transceiver channels and gain benefits of compactness.

Multiple fiber optic transceiver channels can be integrated together on an integrated circuit chip. Testing is important for chips with large array sizes and particularly with the attendant yields of larger array sizes, while the difficulty of testing such chips tends to significantly increase.

There is a need for fiber optic transceiver arrays that are compact and minimize the number of components and connections, providing effective and reliable signal integrity and that allow effective testing of multiple fiber optic transceiver channels. As used in the following description and claims, the terms fiber optic transceiver and fiber optic transceiver channel should be understood to include a fiber optic receiver receiving a light beam input and a transmitter providing a voltage output.

### SUMMARY OF THE INVENTION

A principal object of the present invention is to provide a fiber optic transceiver array for implementing testing. Other important objects of the present invention are to provide such a fiber optic transceiver array for implementing testing substantially without negative effect and that overcome many of the disadvantages of prior art arrangements.

In brief, a fiber optic transceiver array is provided for implementing testing. A fiber optic transceiver array of the invention includes a plurality of sequential fiber optic transceiver channels. Each fiber optic transceiver channel includes a photodetector and has a predefined channel width. The photodetector of each sequential fiber optic transceiver channel is spaced apart substantially equal to the predefined channel width. A plurality of test pads is included in each fiber optic transceiver channel. A pair of power pads is included in each fiber optic transceiver channel.

In accordance with features of the invention, the predefined channel width and spacing between adjacent photodetectors is substantially equal to a spacing between fibers in a standard fiber optic cable. The plurality of test pads of each fiber optic transceiver channel includes a predefined sequence including a ground and a pair of differential channel outputs.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a schematic elevational view illustrating an array of fiber optic transceiver channels in accordance with the preferred embodiment;

FIG. 2 illustrates serial testing of the array of fiber optic transceiver channels of FIG. 1 in accordance with the preferred embodiment; and

FIG. 3 illustrates an exemplary tester for serial testing of fiber optic transceiver channels of FIG. 1 in accordance with the preferred embodiment.

### DETAILED DESCRIPTION OF THE PREFERRED EMBODIMENTS

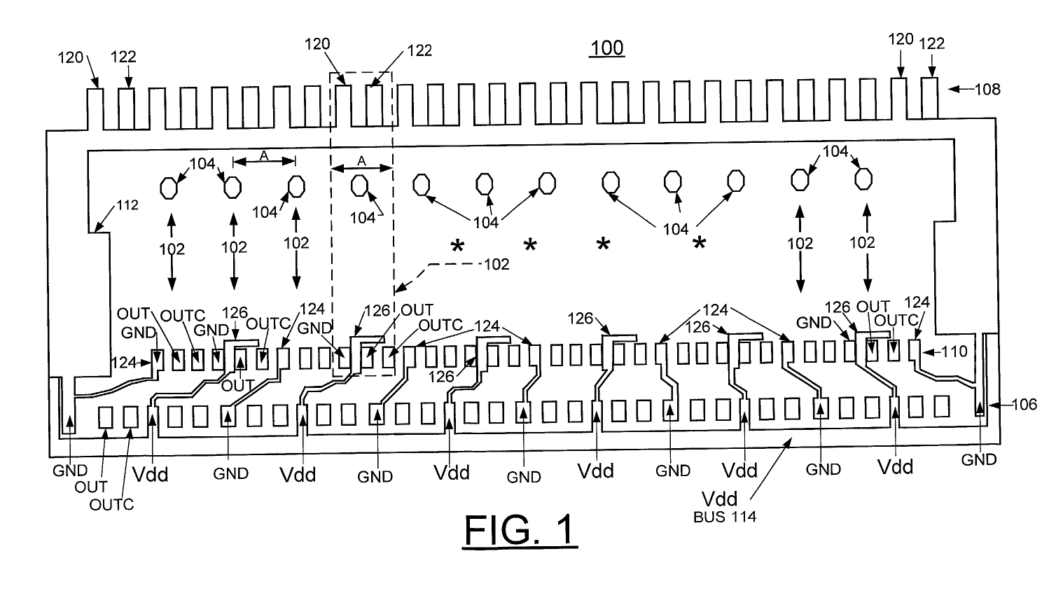

Having reference now to the drawings, in FIG. 1, there is shown an array of fiber optic transceivers generally designated by the reference character 100 in accordance with the preferred embodiment. Fiber optic transceiver array 100 includes a plurality of fiber optic transceiver detectors or fiber optic transceiver channels 102, with one channel 102 indicated in dotted line. In accordance with the preferred embodiment serial testing is implemented for sequential fiber optic transceiver channels 102 in the fiber optic transceiver array 100. One photodetector 104 is included in each of multiple fiber optic transceiver channels 102. As shown in FIG. 1, fiber optic transceiver array 100 includes a series of twelve fiber optic transceiver channels 102, each having an associated one of twelve photodetectors 104. The input to each photodetector 104 is a modulated light beam.

As shown in FIG. 1, fiber optic transceiver array 100 includes a plurality of bottom bond pads 106, a plurality of top power probe pads 108, and a plurality of test probe pads 110 located above the bottom bond pads 106, with three test probe pads 110 included within each channel 102. Power for testing is supplied into the fiber optic transceiver channels 102 of fiber optic transceiver array 100 through the top power probe pads 108.

Fiber optic transceiver array 100 includes a large over-chip, power distribution bypass capacitor 112. Fiber optic transceiver array 100 includes a power source Vdd bus bar 114 that distributes a power source Vdd around the perimeter of the array 100 through the large over-chip, power distribution bypass capacitor 112. Grounds are distributed around the perimeter of the array 100 in a similar manner through bypass capacitor 112. Bypass capacitor 112 minimizes the impedance between ground and power source Vdd.

Power probe pads 108 include alternating ground and power source Vdd pads 120 and 122. One ground pad 120 and power source Vdd pad 122 is included in each fiber optic transceiver channel 102. As shown in FIG. 1, an extra pair of ground and power source Vdd pads 120 and 122 are provided at each end of the series of power probe pads 108. The extra pairs of ground and power source Vdd pads 120 and 122 provide multiple power probe pads 108 for testing the end channels 102 in accordance with the preferred embodiment.

Power noise sensitivity between neighboring fiber optic transceiver channels is provided by a threaded ground connection 124 and a threaded power source Vdd connection 126 respectively provided for alternate fiber optic transceiver channels. Threaded ground test probe pads 110 of alternates ones of the fiber optic transceiver channels 102 are connected to the bottom ground pads 106. Alternate other ones of fiber optic transceiver channels 102 include the threaded power source Vdd connection 126 threaded between the GND and differential output OUT pads 106.

In accordance with features of the preferred embodiment, effective and reliable testing is achieved for fiber optic transceiver array 100 including the parallel fiber optic transceiver channels 102 of the preferred embodiment. Each elongate channel 102 has a predefined width indicated by an arrow A. The photodetectors 104 are uniformly spaced apart substantially equal to the width of channel 102 also indicated by an arrow labeled A. The width A of channel 102 and spacing between photodetectors 104 advantageously is substantially equal to a predefined spacing between fibers in a standard parallel fiber optic cable, for example, at 250 μm.

In accordance with features of the preferred embodiment, three test probe pads 110 are provided per channel width A or per 250 μm within each channel 102 in accordance with the preferred embodiment. One pair of ground and power source Vdd pads 120 and 122 is provided per channel width A or 250 μm within each channel 102 in accordance with the preferred embodiment.

As shown in FIG. 1, each sequential fiber optic transceiver channel 102 in array 100 includes three test probe pads 110 providing connections to ground and differential channel outputs respectively labeled GND, OUT, and OUTC. Bottom bond pads 106 include alternate connections to ground labeled GND and power source labeled Vdd spaced apart by respective connections to differential outputs labeled OUT, and OUTC. Fiber optic transceiver array 100 includes twenty-eight power probe pads 108 and thirty-seven test probe pads 110. An extra ground pad GND, 110 is provided at each end of the series of test probe pads 110 for testing the last channel 102 in array 100 in accordance with the preferred embodiment.

Three probe pads GND, OUT, and OUTC 110 of the preferred embodiment was determined to be much more desirable than four probe pads per channel. Three probe pads GND, OUT, and OUTC, 110 provide more leeway for testing the channels 102 with conventional types of testers or standard wafer testers. While four pads per channel would allow each differential signal to have its own return line for more accurate probing, allowing every other lead to be a ground, this would forego the benefit of the close spacing of the differential channel outputs OUT and OUTC while maintaining possible electromagnetic contamination paths arising from asymmetric grounding.

In accordance with features of the preferred embodiment, the ground probe pad GND, 110 is positioned on the opposite side of the differential channel outputs OUT and OUTC from a next sequential channel 102 in the fiber optic transceiver array 100. The ordering of probe pads 110 as GND, OUT, and OUTC within each channel 102 enables sequential testing of the channels 102 with the ground probe pad GND, 110 of a next channel 102 serving as a return line for a current channel under test. The ordering of probe pads 110 as GND, OUT, and OUTC within each channel 102 also minimizes the spacing between the differential channel outputs OUT and OUTC, reducing the emissions. The GND, OUT, and OUTC ordering of probe pads 110 within each channel 102 also assures that there is a ground between the differential channel outputs OUT and OUTC of each channel 102 to increase isolation between channels.

In accordance with features of the preferred embodiment, serial testing of fiber optic transceiver array 100 is performed. Tester signal and power probes and beam are placed on the first channel 102-1 and stepped by the channel spacing A equal to the standard fiber spacing to test each sequential channel until the last channel 102-12 in the array 100 is tested. Fiber optic transceiver array 100 allows testing to be implemented with an economical tester, avoiding the expense and complexity of designing a tester with the capability to test all channels simultaneously.

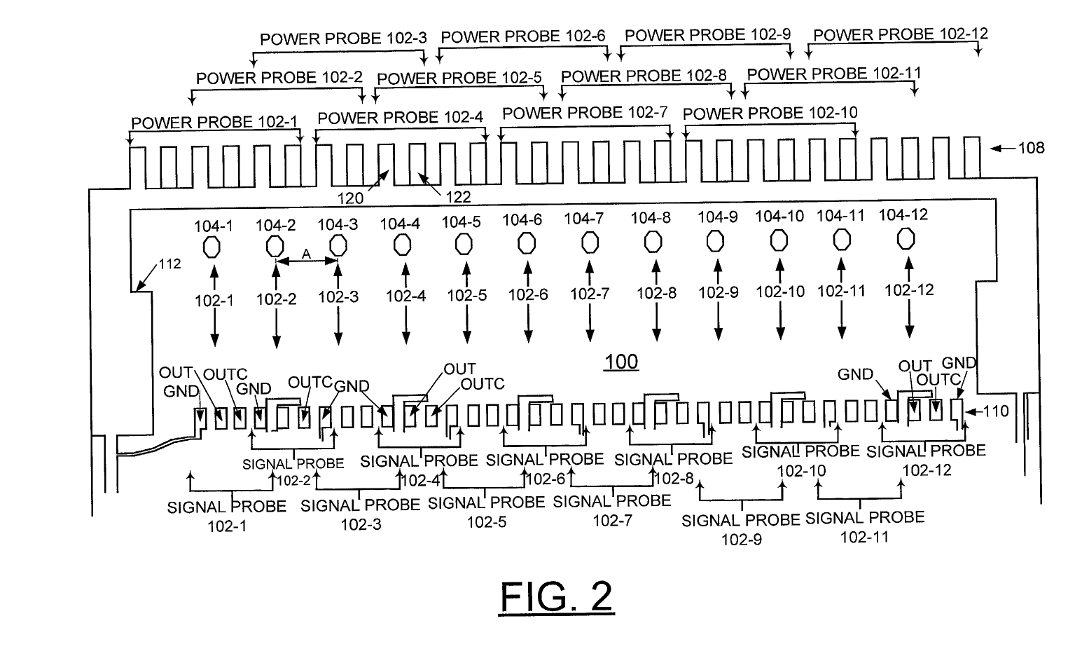

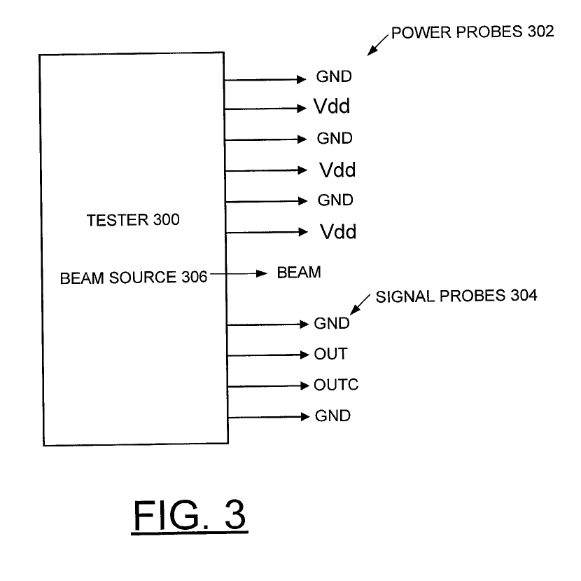

Referring also FIGS. 2 and 3, serial testing of the multiple fiber optic transceivers 102 of the fiber optic transceiver array 100 and an exemplary tester 300 in accordance with the preferred embodiment are illustrated. A standard type of wafer tester 300 includes a plurality of power probes 302 for supplying power to array power pads 108, a plurality of signal probes 304 for probing array test pads 110, and a light source 306 for projecting a light beam onto a photodetector 104. For example, tester 300 includes six power probes 302 for probing three adjacent pairs of ground and power source Vdd pads 120 and 122 of the power test pads 108 and four signal probes for probing four adjacent test probe pads 110 including GND, OUT, and OUTC of a channel 102 and GND or a next sequential channel 102. Tester 300 projects a beam onto the photodetector 104 with the power and signal probes 302 and 304 aligned with the pads.

Multiple power probe pads 108 are used to provide the required current to power all channels 102 in the array 100 simultaneously during testing. Separate power for each channel 102 in the array 100 is not used because this would require more wiring capacity and also reduce the amount of power supplies decoupling per channel that could be obtained. Power for testing is supplied, for example, using the two power probe pads GND and Vdd, 120 and 122 of the channel under test together with the two probe pads GND and Vdd, 120 and 122 of the adjacent channels.

Referring to FIG. 2, serial testing of channels 102-1 through 102-12 is performed. The first channel 102-1 is tested first. A beam is projected onto photodetector 104-1 with power applied to the first three adjacent pairs of ground and power source Vdd pads 120 and 122 of the power test pads 108 and signal probing of the first four adjacent test probe pads 110 including GND, OUT, and OUTC of channel 102-1 and GND of the next sequential channel 102-2. Next the power and signal probes and beam are stepped by the predefined channel width spacing and channel 102-2 is tested. A beam is projected onto photodetector 104-2 with power applied to the three adjacent pairs of ground and power source Vdd pads 120 and 122 of the power test pads 108 and signal probing of the four adjacent test probe pads 110 including GND, OUT, and OUTC of channel 102-2 and GND of the next sequential channel 102-3. Then tester signal and power probes and beam are stepped by the channel spacing A equal to the standard fiber spacing for testing the next sequential channel 102-3 and each sequential channel though the last channel 102-12 in the array 100 is tested.

Except for the first channel 102-1, the ground pad GND, 110 is probed twice. The first pad probed is the ground pad GND, 110 of a current channel under test and the fourth pad probed is the ground pad GND, 110 of the next sequential channel. The second and third pads probed for each channel tested are the differential channel outputs OUT and OUTC for the current channel under test. The last ground pad GND in the test probe pads 110 is used for testing the last channel 102-12, providing a fourth test probe pad for that channel.

While the present invention has been described with reference to the details of the embodiments of the invention shown in the drawing, these details are not intended to limit the scope of the invention as claimed in the appended claims.

What is claimed is:

1. A fiber optic transceiver array for implementing testing comprising:
a plurality of sequential fiber optic transceiver channels; each fiber optic transceiver channel including a photodetector and having a predefined channel width; said photodetector of each sequential fiber optic transceiver channel being spaced apart substantially equal to said predefined channel width;
a plurality of test pads included in each fiber optic transceiver channel; and
a plurality of power pads; a pair of said power pads included in each fiber optic transceiver channel.

2. A fiber optic transceiver array for implementing testing as recited in claim 1 wherein said plurality of test pads included in each fiber optic transceiver channel includes a ground test pad and a pair of differential channel output test pads.

3. A fiber optic transceiver array for implementing testing as recited in claim 2 wherein said ground test pad is spaced apart by said pair of differential channel output test pads of each sequential fiber optic transceiver channel from said ground test pad of a next sequential fiber optic transceiver channel.

4. A fiber optic transceiver array for implementing testing as recited in claim 1 wherein said plurality of test pads included in each fiber optic transceiver channel includes a predefined sequence of test pads; said predefined sequence including a ground and a pair of differential channel outputs.

5. A fiber optic transceiver array for implementing testing as recited in claim 1 wherein said predefined channel width and said spacing between adjacent photodetectors is substantially equal to a predetermined spacing between fibers in a standard fiber optic cable.

6. A fiber optic transceiver array for implementing testing as recited in claim 1 wherein said plurality of test pads included in each fiber optic transceiver channel includes a ground test pad and a pair of differential channel output test pads and wherein one channel of said plurality of sequential fiber optic transceiver channels is tested using said ground test pad and said pair of differential channel output test pads of said one channel being tested and said ground test pad of a next sequential fiber optic transceiver channel.

7. A fiber optic transceiver array for implementing testing as recited in claim 6 include a ground test pad positioned proximate said pair of differential channel output test pads of a last channel of sequential fiber optic transceiver channels; said ground test pad used for testing said last channel of sequential fiber optic transceiver channels.

8. A fiber optic transceiver array for implementing testing as recited in claim 6 wherein said pair of power pads included in said one channel being tested and said pair of power pads included in at least one adjacent sequential fiber optic transceiver channel are used for supplying power to said one channel being tested.

9. A fiber optic transceiver array for implementing testing as recited in claim 1 wherein said predefined channel width and said spacing between adjacent photodetectors is equal to approximately 250 μm.

10. A fiber optic transceiver array for implementing testing as recited in claim 1 wherein spacing between said pair of differential channel output test pads is minimized.

11. A fiber optic transceiver array for implementing testing comprising:
a plurality of sequential fiber optic transceiver channels; each fiber optic transceiver channel including a photodetector and having a predefined channel width; said photodetector of each sequential fiber optic transceiver channel being spaced apart substantially equal to said predefined channel width;
a plurality of sequential test pads for test signal probing included within said predefined channel width of each fiber optic transceiver channel; said sequential test pads including a ground test pad and a pair of differential output test pads; and
a plurality of power pads for supplying power for testing; a pair of power pads included within said predefined channel width of each fiber optic transceiver channel.

12. A fiber optic transceiver array for implementing testing as recited in claim 11 wherein said predefined channel width is equal to approximately 250 μm.

13. A fiber optic transceiver array for implementing testing as recited in claim 11 wherein serial testing of each of said plurality of sequential fiber optic transceiver channels is performed; and wherein one channel of said plurality of sequential fiber optic transceiver channels is tested using said ground test pad and said pair of differential channel output test pads of said one channel being tested and said ground test pad of a next sequential fiber optic transceiver channel.

14. A fiber optic transceiver array for implementing testing as recited in claim 13 include a ground test pad positioned proximate to said pair of differential channel output test pads of a last channel of sequential fiber optic transceiver channels; said ground test pad used for testing said last channel of sequential fiber optic transceiver channels.

15. A fiber optic transceiver array for implementing testing as recited in claim 13 wherein said pair of power pads included in said one channel being tested and said pair of power pads included in at least one adjacent sequential fiber optic transceiver channel are used for supplying power to said one channel being tested.

16. A fiber optic transceiver array for implementing testing as recited in claim 11 wherein spacing between said pair of differential channel output test pads is minimized.

17. A method for implementing testing of a fiber optic transceiver array, the fiber optic transceiver array including a plurality of sequential fiber optic transceiver channels; each fiber optic transceiver channel including a photodetector and having a predefined channel width; said photodetector of each sequential fiber optic transceiver channel spaced apart substantially equal to said predefined channel width; each fiber optic transceiver channel including a plurality of sequential test pads and a pair of power pads disposed within said predefined channel width; said sequential test pads including a ground test pad and a pair of differential output test pads; said method comprising the steps of:
(a) projecting a light beam onto said photodetector of a first sequential fiber optic transceiver channel being tested;
(b) applying power probes to said pair of power pads included within said predefined channel width of said first fiber optic transceiver channel being tested and to at least one adjacent pair of power pads;
(c) applying test signal probes to a first four sequential test pads including said ground test pad and said pair of differential output test pads of said first fiber optic transceiver channel being tested and to said ground test pad of a next sequential fiber optic transceiver channel;
(d) moving said light beam, said power probes, and said test signal probes substantially equal to said predefined channel width and repeating steps a, b, and c, to test each sequential fiber optic transceiver channel.

18. A method for implementing testing of a fiber optic transceiver array as recited in claim 17 wherein the step of: (b) applying power probes to said pair of power pads included within said predefined channel width of said first fiber optic transceiver channel being tested and to at least one adjacent pair of power pads includes the step of:
(b) applying power probes to said pair of power pads included within said predefined channel width of said first fiber optic transceiver channel being tested and to two adjacent pairs of power pads.

19. A method for implementing testing of a fiber optic transceiver array as recited in claim 17 wherein the step of: (d) moving said light beam, said power probes, and said test signal probes substantially equal to said predefined channel width includes the step of:
(d) moving said light beam, said power probes, and said test signal probes substantially equal to a predetermined spacing between fibers in a standard fiber optic cable.
